(19) United States
(12) Patent Application Publication
(10) Pub. No.: US 2017/0229207 A1
(43) Pub. Date: Aug. 10, 2017

(54) LAMINATION COMPOSITE OF BORON NITRIDE IN PAPER FOR TRANSFORMER INSULATION

(71) Applicant: Momentive Performance Materials Inc., Waterford, NY (US)

(72) Inventors: Hao Qu, Westlake, OH (US); Lada Bemert, Cologne (DE); Johannes Delis, Bergen op Zoom (NL); Oliver Safarowsky, Cologne (DE)

(21) Appl. No.: 15/500,953

(22) PCT Filed: Sep. 25, 2015
(86) PCT No.: PCT/US15/52261

§ 371 Date: Feb. 1, 2017

Related U.S. Application Data
(60) Provisional application No. 62/056,032, filed on Sep. 26, 2014.

(51) Int. Cl. H01B 3/00; B32B 37/12; B32B 29/06; B32B 7/12; H01B 19/04; B32B 29/00

(52) U.S. Cl. CPC H01B 3/004; H01B 19/04; B32B 29/005; B32B 29/06; B32B 7/12; B32B 37/12; B32B 2037/1253; B32B 2255/12; B32B 2255/26; B32B 2305/72; B32B 2307/302; B32B 2307/206; B32B 2264/107; B32B 2317/122; B32B 2315/02; B32B 2383/00; B32B 2457/04

(57) ABSTRACT

The present technology provides an electrical insulating material comprising a plurality of insulating dielectric layers and a thermally conductive layer disposed between adjacent dielectric layers, the thermally conductive layer comprising a thermally conductive filler. Additionally, the present technology also provides a method of manufacturing the electrical insulating material. The present technology also provides an electrically conductive apparatus comprising an electrically conductive material and an electrical insulating material disposed about the conductive material, the electrical insulating material comprising a first dielectric layer, a second dielectric layer overlying the first dielectric layer, and a thermally conductive layer disposed between the first and second dielectric layers, the thermally conductive layer comprising a thermally conductive filler, e.g., born nitride.

### CROSS-REFERENCE TO RELATED APPLICATIONS

This application claims priority to and the benefit of U.S. Provisional Application No. 62/056,032 titled “Lamination Composite of Boron Nitride in Paper for Transformer Insulation,” filed on Sep. 26, 2014, the entire disclosure of which is incorporated herein by reference in its entirety.

### FIELD

The present technology relates to an electrical insulating material, and, in particular, to an electrical insulating material that also provides thermal conductivity. The present technology also relates to electrically conductive structures comprising such electrical insulating materials and methods of making such electrical insulating materials and electrically conductive structures.

### BACKGROUND

Various dielectric materials are employed as electrical insulators in apparatuses such as transformers, capacitors, coils, motors, generators, turbo generators, etc. The conventional materials that are employed as dielectrics in a solid form are relatively poor heat conductors and are subject to breakdown if they are heated above the decomposition temperature. Due to its high dielectric strength, paper is often employed as an electrical insulator in the manufacture of various types of equipment. However, since paper is a poor thermal conductor, its use is generally limited to those applications where heat dissipation is not a problem.

To avoid these adverse effects, the heat that is generated within an electrical apparatus due to power loss should be kept at a minimum or the dielectric material should be capable of conducting heat effectively. While attempts have been made to modify insulating materials such that they are also thermally conductive, it is still desirable to find materials that exhibit suitable thermal conductivity.

### SUMMARY

The present technology provides, in one aspect, an electrical insulating material that also exhibits good thermal conductivity. The present material can provide an electrical insulator with excellent thermal conductivity without compromising the electrical insulation and other performance properties. The present technology provides an electrical insulating material that is capable of dissipating heat and allowing for more efficient electrical conversion.

In one aspect, the present technology provides an electrical insulating material comprising a plurality of dielectric layers, and a thermally conductive layer disposed between adjacent dielectric layers, the thermally conductive layer comprising a thermally conductive filler.

In one embodiment, the present technology provides an electrical insulating material wherein the thermally conductive layer comprises a thermally conductive filler disposed in a carrier.

The present technology provides an electrical insulating material according to any previous embodiment, wherein the carrier is chosen from a carrier oil or a resin. The present technology provides an electrical insulating material according to any previous embodiment, wherein the carrier oil is chosen from a natural oil or a synthetic oil. The present technology provides an electrical insulating material according to any previous embodiment, wherein the carrier oil is chosen from a mineral oil, a vegetable oil, or a combination of two or more thereof. The present technology provides an electrical insulating material according to any previous embodiment, wherein the carrier oil is chosen from a polyol, an ester, an epoxide, a silicone oil, a polyolefin, a polyalphaolefin glycol, a polyalkylene glycol, a paraffin, an isoparrafin, a cycloparaffinic mineral oil, soybean oil, canola oil, castor oil, palm oil, olive oil, corn oil, cottonseed oil, sesame seed oil, or a combination of two or more thereof

The present technology provides an electrical insulating material according to any previous embodiment, wherein the thermally conductive filler further comprises an additive selected from bentonite, tackifiers, aliphatic rosin esters, terpenes, phenols, aliphatic synthetic hydrocarbon resins, aromatic synthetic hydrocarbon resins, pigments, reinforcing agents, hydrophobic silica, hydrophilic silica, calcium carbonate, toughening agents, fibers, fillers, antioxidants, stabilizers, and combinations of two or more thereof.

The present technology provides an electrical insulating material according to any previous embodiment, wherein the carrier is chosen from water, an organic solvent, or a combination thereof.

The present technology provides an electrical insulating material according to any previous embodiment, wherein the present technology provides an electrical insulating material wherein the carrier is chosen from a resin.

The present technology provides an electrical insulating material according to any previous embodiment, wherein the carrier is chosen from an epoxy, a polydimethylsiloxane, an acrylate, an organo-functionalized polysiloxane, a polyimide, a fluorocarbon, a benzocyclobutene, a fluorinated polyallyl ether, a polyamide, a polyimidoamide, a phenol cresol, an aromatic polyester, a polyphenylene ether (PPE), a bismaleimide, a fluororesin, or a combination of two or more thereof.

The present technology provides an electrical insulating material according to any previous embodiment, wherein the carrier material is chosen from a silicone, polydimethyl siloxane, polyalkylsiloxane, polyarylsiloxane, polyalkylarylsiloxane, polyethersiloxane copolymers, or a combination of two or more thereof.

The present technology provides an electrical insulating material according to any previous embodiment, wherein the carrier material is chosen from a polymer or combination of two or more polymers.

The present technology provides an electrical insulating material according to any previous embodiment, wherein the polymers are cross-linked by the following mechanisms: radical polymerization; anionic polymerization; kationic polymerization; polycondensation; polyaddition; hydrosilylation; Ziegler-Natta-polymerization; metathesepolymerization; or a combination of two or more thereof.

The present technology provides an electrical insulating material according to any previous embodiment, wherein the polymers are cured by the following methods: cured thermally; cured by radiation; cured at room temperature conditions; cured by an oxidative-curing system; cured by a moisture-curing system; physically cured; or a combination of two or more methods thereof.

The present technology provides an electrical insulating material according to any previous embodiment, wherein the polymers have an average molecular weight from about 150 to about 1,000,000 Daltons.

The present technology provides an electrical insulating material according to any previous embodiment, wherein the present technology provides an electrical insulating material wherein the thermally conductive layer comprises the thermally conductive filler in an amount of 0.1 weight percent to about 80 weight percent.

The present technology provides an electrical insulating material according to any previous embodiment, wherein the thermally conductive filler comprises boron nitride platelets, agglomerates, or a combination of both.

The present technology provides an electrical insulating material according to any previous embodiment, wherein the electrical insulating material has a total thermally conductive filler loading from about 0.1 percent to about 50 percent by weight of the electrical insulating material.

The present technology provides an electrical insulating material according to any previous embodiment, wherein the thermal conductivity of the electrical insulating material is at least 0.1 W/mK.

The present technology provides an electrical insulating material according to any previous embodiment, wherein the thermally conductive layer further comprises a fire retardant material.

The present technology provides an electrical insulating material according to any previous embodiment, wherein the dielectric layers are chosen from a woven fibrous material, a non-woven fibrous material, a film, a laminate, or a combination of two or more thereof

The present technology provides an electrical insulating material according to any previous embodiment comprising at least two dielectric layers.

The present technology provides an electrical insulating material according to any previous embodiment comprising at least five dielectric layers.

The present technology provides an electrical insulating material according to any previous embodiment comprising at least ten dielectric layers.

The present technology provides an electrical insulating material according to any previous embodiment comprising at least 2-15 dielectric layers.

In one aspect, the present technology provides an electrical insulating material comprising a first dielectric layer, a second dielectric layer overlying the first dielectric layer, and a thermally conductive layer disposed between the first and second dielectric layers, the thermally conductive layer comprising a thermally conductive filler. The dielectric layers and the thermally conductive layer may be as described with respect to any previous embodiment.

In one aspect, the present technology provides an electrical insulating material comprising a dielectric layer comprising a first and a second surface; and a first thermally conductive layer disposed about the first dielectric layer, the first thermally conductive layer comprising a first thermally conductive filler. The dielectric layer and the thermally conductive layer may be as described with respect to any previous embodiment.

In one embodiment, electrical insulating material further comprises a second thermally conductive layer disposed about the second surface of the dielectric layer, the second thermally conductive layer comprising a second thermally conductive filler. The dielectric layer and the thermally conductive layer may be as described with respect to any previous embodiment.

In one aspect, the present technology provides an electrically conductive apparatus comprising an electrically conductive material and an electrical insulating material disposed about the conductive material. The electrical insulating material comprises a first dielectric layer, a second dielectric layer overlying the first dielectric layer, and a thermally conductive layer disposed between the first and second dielectric layers, the thermally conductive layer comprising a thermally conductive filler. The dielectric layers and the thermally conductive layer may be as described with respect to any previous embodiment.

In one embodiment, the present technology provides an electrically conductive apparatus wherein the electrically conductive material is a metal.

In another aspect, the present technology provides a method for manufacturing an electrical insulating material comprising the steps of (i) coating an exposed surface of a first dielectric layer with a composition comprising a thermally conductive filler disposed in a carrier and (ii) applying a second dielectric layer onto the coated surface of the first dielectric layer to provide an electrical insulating material. Coating of the dielectric layer onto the exposed surface can be accomplished using different application methods, for example brushing, roll, roll to roll, mayer bar, knife, casting, spraying and printing.

In one embodiment, the present technology provides a method for manufacturing an electrical insulating material further comprising the step of applying pressure to the electrical insulating material.

In one embodiment, the present technology provides a method for manufacturing an electrical insulating material further comprising the steps of coating an exposed surface of the second dielectric layer with the coating composition and applying a third dielectric layer onto the coated surface of the second dielectric layer.

In one aspect, the present technology relates to an electrical insulating material comprising a plurality of dielectric layers chosen from a paper material, a cellulosic based material, or a combination of two or more thereof; and a thermally conductive layer disposed between adjacent dielectric layers, the thermally conductive layer comprising a boron nitride filler disposed in a carrier chosen from a mineral oil, a silicone based material, or a combination of two or more thereof.

In one embodiment, the boron nitride filler is chosen from hexagonal boron nitride, platelet boron nitride, an agglomerate of boron nitride, a boron nitride nanotube, a boron nitride fiber, a boron nitride nanosheet, or a combination of two or more thereof.

The insulating material of any previous embodiment, wherein the carrier comprises an organofunctionalized siloxane.

The insulating material of any previous embodiment, wherein the carrier comprises polydimethylsiloxane.

The insulating material of any previous embodiment, wherein at least one of the plurality of dielectric layers comprises KRAFT paper.

The insulating material of any previous embodiment, wherein at least one of the plurality of dielectric layers comprises a cellulosic based material.

The insulating material of any previous embodiment, wherein the thermally conductive layer comprises the boron nitride filler in an amount of from about 15 to about 50 wt. %, and the carrier in an amount of from about 50 to about 85 wt. %.

The insulating material of any previous embodiment, wherein the thermally conductive layer comprises the boron nitride filler in an amount of from about 20 to about 40 wt. %, and the carrier in an amount of from about 60 to about 80 wt. %.

In one aspect, the present technology provides an electrically conductive apparatus comprising an electrically conductive material and an electrical insulating material disposed about the conductive material, where the electrical insulating material may be an electrical insulating material according to any of the previous embodiments.

In one aspect, the present technology provides, a composition comprising (a) a curable silicone-based composition; and (b) a boron nitride filler material.

In one embodiment, the curable silicone-based composition is chosen from a photocurable composition, a thermal curable composition, or a combination of two or more thereof

The technology also provides a composition according to any of the previous embodiments, wherein the curable silicone-based composition comprises an unsaturated silicone and a silyl hydride.

The technology also provides a composition according to any of the previous embodiments, wherein the unsaturated silicone compound is chosen from an alkenyl silicone compound of the formula:

QᵤTₚT_{p′}^{vi}D_{w}D^{vi}ₓM^{vi}_{y}M_{z},

wherein Q is SiO_{4/2}, T is R¹SiO_{3/2}, T^{vi} is R²SiO_{3/2}, D is R¹₂SiO_{2/2}, D^{vi} is R¹ R²SiO_{2/2}, M^{vi} is R²_{g}R¹_{3-g}SiO_{1/2}, M is R¹₃SiO_{1/2}; R² is vinyl; each occurrence of R¹ is independently C1-C18 alkyl, C1-C18 substituted alkyl, aryl, substituted aryl, wherein R¹ optionally contains at least one heteroatom; each g has a value of from 1 to 3, p is from 0 to 20, u is from 0 to 20, v is from 0 to 20, w is from 0 to 5000, x is from 0 to 5000, y is from 0 to 20, and z is from 0 to 20, provided that v+p+p′+w+x+y equals 1 to 10,000, and the valences of all of the elements in the compound containing at least one unsaturated group are satisfied; and

the silyl hydride is chosen from a compound of the formula M′ₐM^{H}_{b}D′_{c}D^{H}_{d}T′ₑT^{H}_{f}Q′ₕ, where subscripts a, b, c, d, e, f, and h are such that the molar mass of the siloxane-type reactant is between 100 and 100,000 Dalton and that there are at least two hydride atoms in the silyl hydride. M′ group is chosen from a monofunctional group of formula R³₃SiO_{1/2}, D′ is chosen from a difunctional group of formula R³₂SiO_{2/2}, T′ is chosen from a trifunctional group of formula R³SiO_{3/2}, and Q′ is chosen from a tetrafunctional group of formula SiO_{4/2}, M^{H} is chosen from HR³₂SiO_{1/2}, T^{H} is chosen from HSiO_{3/2}, D^{H} is chosen from R³HSiO_{2/2}, where each occurrence of R³ is independently C1-C40 alkyl, C1-C40 substituted alkyl, C6-C14 aryl or substituted aryl, wherein R³ optionally contains at least one heteroatom.

The technology also provides a composition according to any of the previous embodiments, wherein the alkenyl silicone is a compound of the formula M^{vi}D_{w}M^{vi}.

The technology also provides a composition according to any of the previous embodiments, wherein the boron nitride filler is chosen from hexagonal boron nitride, platelet boron nitride, an agglomerate of boron nitride, a boron nitride nanotube, a boron nitride fiber, a boron nitride nanosheet, or a combination of two or more thereof

The present technology also provides, in still another aspect, a dielectric layer coated with the composition of any of the previous embodiments.

These and other aspects and embodiments are further understood with reference to the following detailed description.

### BRIEF DESCRIPTION OF THE DRAWINGS

FIG. 1 is a cross-sectional view of an electrical insulating material in accordance with an embodiment of the present technology;

FIG. 2 is a cross-sectional view of an electrical insulating material in accordance with an embodiment of the present technology;

FIG. 3 is a cross-sectional view of an electrical insulating material in accordance with an embodiment of the present technology;

FIG. 4 is a cross-sectional view of an electrical insulating material in accordance with an embodiment of the present technology;

FIG. 5 is a cross-sectional view of an electrically conductive apparatus in accordance with an embodiment of the present technology;

FIG. 6 is a cross-sectional view of another electrically conductive apparatus in accordance with an embodiment of the present technology;

FIG. 7 is a graph depicting the parallel-to-layer thermal conductivity of various electrical insulating materials;

FIG. 8 is a graph depicting the vertical-to-layer thermal conductivity of various electrical insulating materials;

FIG. 9 is a graph depicting the overall thermal conductivity of various electrical insulating materials;

FIG. 10 is a graph depicting the parallel-to-layer thermal conductivity of various electrical insulating materials;

FIG. 11 is a graph depicting the vertical-to-layer thermal conductivity of various electrical insulating materials;

FIG. 12 is a graph depicting the overall thermal conductivity of various electrical insulating materials;

FIG. 13 is a graph depicting the through plane thermal conductivity of various electrical insulating materials;

FIG. 14 is a graph depicting the in-plane thermal conductivity of various electrical insulating materials; and

FIG. 15 is a graph depicting the hot disk thermal conductivity of various electrical insulating materials.

The drawings are not to scale unless otherwise noted. The drawings are for the purpose of illustrating aspects and embodiments of the present technology and are not intended to limit the technology to those aspects illustrated therein. Aspects and embodiments of the present technology can be further understood with reference to the following detailed description.

### DETAILED DESCRIPTION

The present technology provides, in one aspect, an electrical insulating material having good thermal conductivity. The electrical insulating material comprises a dielectric layer comprising a thermally conductive layer disposed about a surface of the dielectric layer. The thermally conductive layer comprises a thermally conductive filler. The electrical insulating material is capable of dissipating heat and allowing for more efficient electrical conversion.

The electrical insulating material can be provided in a variety of configurations. In one embodiment, the electrical insulating material can be provided with a single dielectric layer having a thermally conductive layer disposed about the surface of the dielectric layer. In another embodiment, the electrical insulating material comprises a plurality of layers comprising dielectric materials and a thermally conductive layer disposed between adjacent dielectric layers, where the thermally conductive layer comprises a thermally conductive filler.

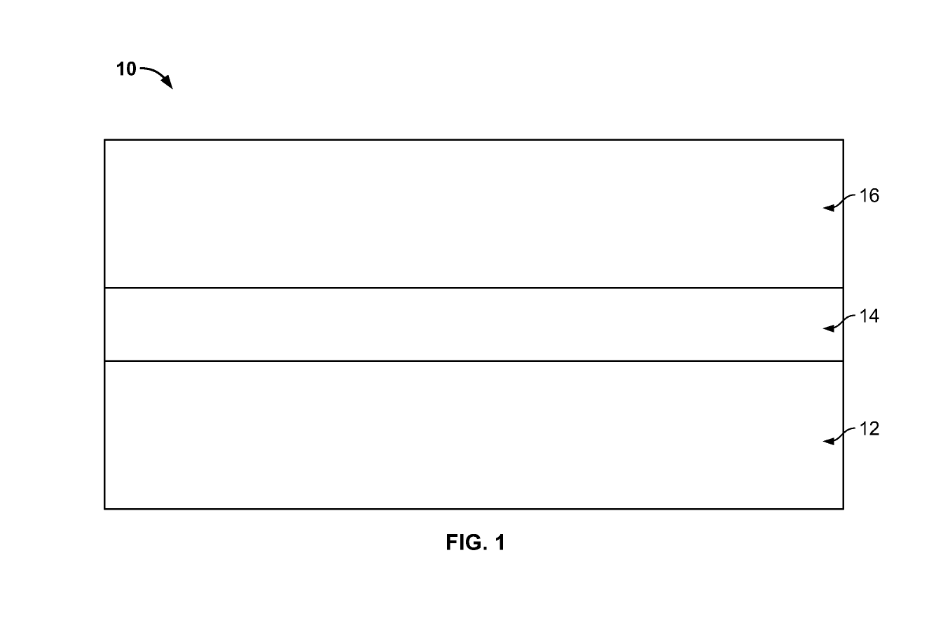

As shown in FIG. 1, the present technology provides, in one aspect, an electrical insulating material 10 comprising a first dielectric layer 12, a second dielectric layer 16 overlying the first dielectric layer 12, and a thermally conductive layer 14 disposed between the first dielectric layer 12 and the second dielectric layer 16.

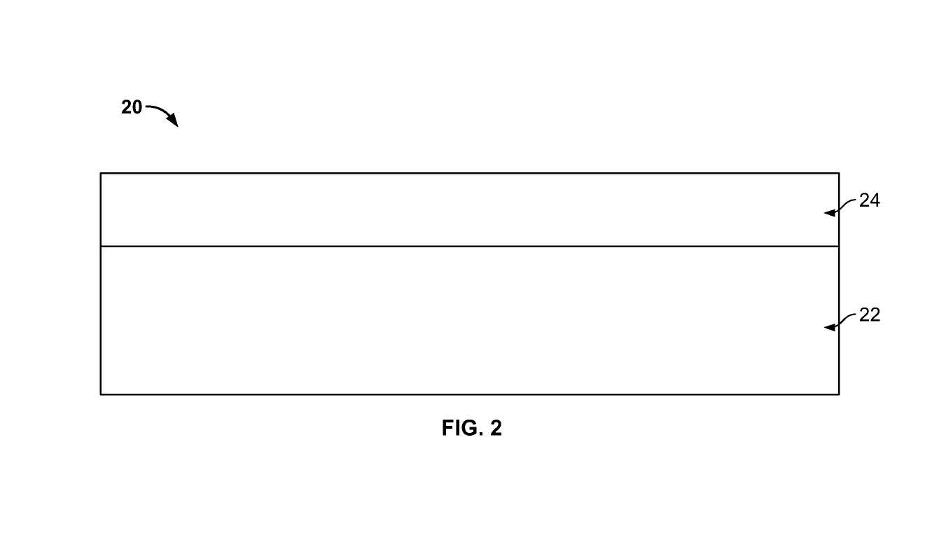

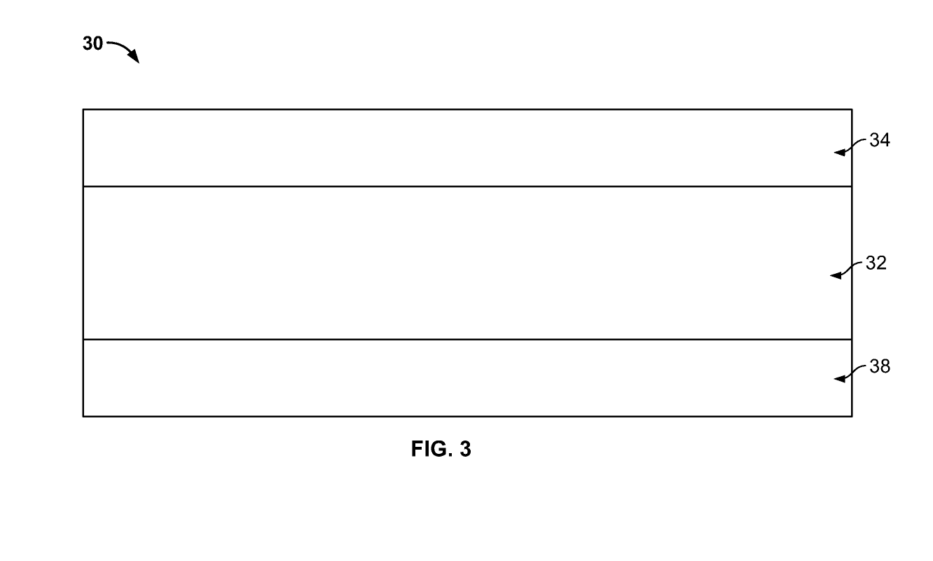

It will be appreciated that the number of dielectric layers in the electrical insulating material is generally not limited. The electrical insulating material may include two dielectric layers, as shown in the embodiment of FIG. 1. However, the electrical insulating material may include one dielectric layer or even more than two dielectric layers. The electrical insulating material may include one, two, three, four, five or more dielectric layers. In one embodiment, the electrical insulating material comprises 1-15 dielectric layers, 3-10 dielectric layers, even 4-7 dielectric layers. The number of layers may be selected as desired to provide a material with suitable physical properties and to allow for the dissipation of heat and efficient conversion of electricity. FIG. 2 illustrates an embodiment with an electrical insulating material 20 including a dielectric layer 22 and a thermally conductive layer 24 overlying the dielectric layer 22. FIG. 3 illustrates an embodiment with an electrical insulating material 30 including a dielectric layer 32 having at least a first and second surface. A first thermally conductive layer 34 is disposed about the first surface of the dielectric layer 32. A second thermally conductive layer 38 is disposed about the second surface of the dielectric layer 32.

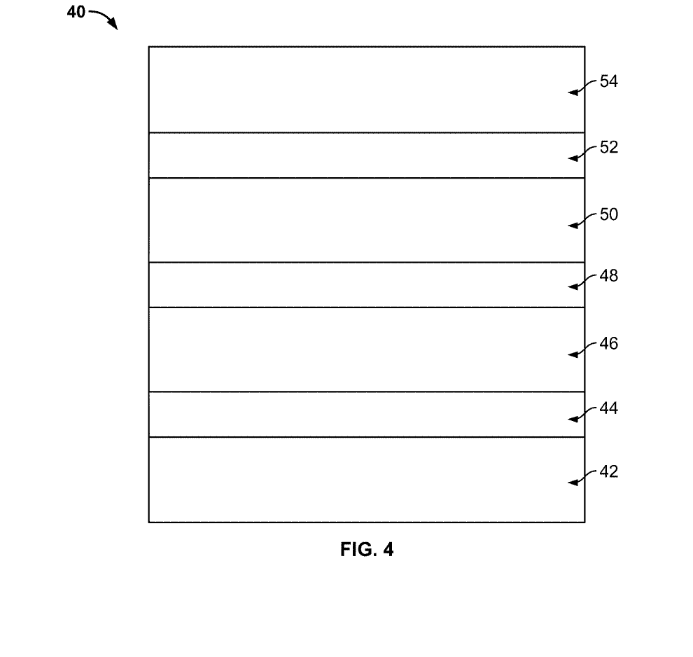

FIG. 4 illustrates an embodiment of an electrical insulating material 40 that includes four dielectric layers. In FIG. 4, the electrical insulating material 40 includes a first dielectric layer 42, a second dielectric layer 46 overlying the first dielectric layer 42, and a thermally conductive layer 44 disposed between the first dielectric layer 42 and the second dielectric layer 46. Additionally, the electrical insulating material 40 includes a third dielectric layer 50 overlying the second dielectric layer 46 with a thermally conductive layer 58 comprising a thermally conductive filler disposed between the second and third dielectric layers 56 and 50. The electrical insulating material 50 further includes a fourth dielectric layer 54 overlying the third dielectric layer 50 with a thermally conductive layer 52 comprising thermally conductive filler disposed between the third dielectric layer 50 and the fourth dielectric layer 54.

While the embodiment in FIG. 4 has a thermally conductive layer disposed between each adjacent pair of dielectric layers, it will be appreciated that the electrical insulating material does not have to be so configured. In one embodiment, more than one dielectric layer may be disposed adjacent to another dielectric layer with no thermally conductive layer disposed between the successive dielectric layers. For example, in one embodiment, the electrical insulating material may include a first dielectric layer, a second dielectric layer overlying the first dielectric layer, and a thermally conductive layer disposed between the first and second dielectric layers. Additionally, the electrical insulating material may include a third dielectric layer overlying the second dielectric layer with no thermally conductive layer disposed between the second and third dielectric layers. More than one dielectric layer may overlie another dielectric layer where there is no thermally conductive layer disposed between. Other embodiments and arrangements of such configurations are also possible.

The dielectric layer is generally not limited and may be provided by any suitable dielectric material. The dielectric material can be chosen, for example, from woven or non-woven fibrous material, films, and laminates. Non-limiting examples of such materials include paper or board structures. For example, the dielectric layers may be a paper, e.g., KRAFT paper, cloth, non-woven fabric, or any other appropriate insulating material. The dielectric layer may have cellulose as major constituent. Alternatively, the paper may be formed from mixtures of fibrous cellulosic materials and fibrous glass or mica. Further, the fibrous cellulose materials may be used conjointly with a mica sheet, synthetic resin film, glass cloth, glass paper, boron nitride fiber, boron nitride nanosheets, boron nitride nanotubes, or any other appropriate material. Other examples of suitable dielectric materials include papers or boards that are composed of aramid fibers, such as m-aramid fibers or p-aramid fibers.

The dielectric layers can be provided by the same or different materials. In one embodiment, each dielectric layer can be provided by the same type of material. In one embodiment, two or more dielectric layers can have different compositions and/or a different material.

The thermally conductive layer comprises a thermally conductive filler. The thermally conductive filler may be selected from hexagonal boron nitride, zinc oxide, glass fiber, glass flake, clays, exfoliated clays, calcium carbonate, talc, mica, wollastonite, aluminosilicate, alumina, aluminum nitride, graphite, metallic powders or flakes of aluminum, copper, bronze, or brass, fibers or whiskers of aluminum, copper, bronze, brass, silicon carbide, silicon nitride, aluminum nitride, alumina, zinc oxide, or a combination of two or more thereof, carbon nanotubes, graphene, boron nitride nanoparticles, boron nitride nanotubes, boron nitride nanosheets, boron nitride fibers, zinc oxide nanotubes, or a combination of two or more thereof

In one embodiment, the thermally conductive filler loading in the thermally conductive layer is approximately 0.1 to 80 wt. % (of the total weight of the thermally conductive layer); 10 to 75 wt. %; 15 to 50 wt. %; even 20 to 30 wt. %. Here, as elsewhere in the specification and claims, numerical values can be combined to form new or non-disclosed ranges.

A particularly suitable thermally conductive filler is boron nitride. The form of the boron nitride used for the thermally conductive filler is not particularly limited. Boron nitride is commercially available from a number of sources, including, but not limited to, Momentive Performance Materials Inc., Sintec Keramik, Kawasaki Chemicals, St. Gobain Ceramics, etc. Without being bound to any particular theory, the boron nitride may serve as a lubricant between the dielectric layers of the electrical insulating material and release the stress and deformation introduced to the dielectric layer by magnetoconstriction during the operation of an electrically conductive material around which the electrical insulating material is encased.

The form of boron nitride used in the thermally conductive filler is not limited and can be chosen from, for example, amorphous boron nitride (referred to herein as a-BN); boron nitride of the hexagonal system, having a laminated structure of hexagonal-shaped meshed layers (referred to herein as h-BN); or a turbostratic boron nitride, having randomly oriented layers (referred to herein as t-boron nitride); platelet boron nitride; boron nitride fibers; boron nitride agglomerates; boron nitride nanotubes, etc., or combination of two or more thereof In one embodiment, the boron nitride is in the platelet form, turbostratic form, hexagonal form, or mixtures of two or more thereof

The size of the boron nitride particles employed in forming the thermally conductive filler can be selected as desired for a particular purpose or intended use. In one embodiment, the particle size can range from nanometers to micron size particles In one embodiment, the boron nitride powder has an average particle size of about 0.05 μm to about 500 μm; from about 0.5 μm to about 250 μm; from about 1 μm to about 150 μm; from about 5 μm to about 100 μm; even from about 10 μm to about 30 μm. In one embodiment, the boron nitride powder has an average particle size of at least 50 μm. In one embodiment, the boron nitride powder comprises irregularly shaped agglomerates of hBN platelets, having an average particle size of above 10 μm. Here, as elsewhere in the specification and claims, numerical values can be combined to form new and non-disclosed ranges.

The thermally conductive layer can be a coating layer and may have in a dried or fluid state. The thermally conductive layer may be provided as a composition comprising a thermally conductive filler disposed in a carrier component. The thermally conductive filler may be fixed or moveable in the carrier component. Different common coating methods can be used for deposition of the thermally conductive layer, such as brushing, roll, roll to roll, mayer bar, knife, casting, spraying and printing. Thermally conductive foil can be stuck to the surface by common glue techniques.

The boron nitride component can comprise crystalline or partially crystalline boron nitride particles made by processes known in the art. These include spherical boron nitride particles in the micron size range produced in a process utilizing a plasma gas as disclosed in U.S. Pat. No. 6,652,822; hBN powder comprising spherical boron nitride agglomerates is formed from irregular non-spherical boron nitride particles bound together by a binder and subsequently spray-dried, as disclosed in U.S. Patent Publication No. 2001/0021740; boron nitride powder produced from a pressing process as disclosed in U.S. Pat. Nos. 5,898,009 and 6,048,511; boron nitride agglomerated powder as disclosed in U.S. Patent Publication No. 2005/0041373; boron nitride powder having high thermal diffusivity as disclosed in U.S. Patent Publication No. 2004/0208812A1; and highly delaminated boron nitride powder as disclosed in U.S. Pat. No. 6,951,583. These also include boron nitride particles of the platelet morphology.

In another embodiment, the boron nitride powder is in the form of spherical agglomerates of hBN platelets. In one embodiment of spherical boron nitride powder, the agglomerates have an average agglomerate size distribution (ASD) or diameter from about 10 μm to about 500 μm. In another embodiment, the boron nitride powder is in the form of spherical agglomerates having an ASD in the range of about 30 μm to about 125 μm. In one embodiment, the ASD is about 74 to about 100 microns. In another embodiment, about 10 μm to about 40 μm. Here, as elsewhere in the specification and claims, numerical values can be combined to form new and non-disclosed ranges.

In one embodiment, the boron nitride powder is in the form of platelets having an average length along the b-axis of at least about 1 micron, and typically between about 1 μm and 20 μm, and a thickness of no more than about 5 microns. In another embodiment, the powder is in the form of platelets having an average aspect ratio of from about 50 to about 300.

In one embodiment, the boron nitride particles comprise hBN platelets having an aspect ratio of from about 10 to about 300. In another embodiment, the boron nitride particles have an oxygen content from 0.2 to 2.5 wt. %. In another embodiment, the hBN particles have a graphitization index of less than 7.

In one embodiment, the boron nitride is surface-treated (“coated”) to further impart lubricating characteristics to the ingredient. Examples of surface coating materials for the boron nitride powder include, but are not limited to, reactive silane, isohexadecane, liquid paraffin, non-ionic surfactants, dimethylpolysiloxane (or dimethicone), a mixture of completely methylated, linear siloxane polymers which have been terminally blocked with trimethylsiloxy units, a silazane compound possessing perfluoroalkyl groups, a titanate coupling agent, a zirconate coupling agent, a zirconium aluminate coupling agent, an aluminate coupling agent, and mixtures thereof. In one embodiment, the boron nitride is coated in a reactive silane which may covalently bond to the boron nitride particles and to a surrounding carrier, e.g., a polysiloxane. The presence of the covalent bonds may ensure the transfer of phonons (“lattice vibrations”) from the boron nitride crystals in to the polymer matrix. These covalent bonds may avoid the difficulties of thermal energy transfer and may increase the overall thermal conductivity by 10-15%.

In one embodiment, the boron nitride loading in the thermally conductive layer is approximately 0.1 to 80 wt. % (of the total weight of the thermally conductive layer); 10 to 75 wt. %; 15 to 50 wt. %; even 20 to 30 wt. %. Here, as elsewhere in the specification and claims, numerical values can be combined to form new or non-disclosed ranges.

The carrier selected for the thermally conductive layer may affect the nature of the electrically insulating material. A carrier material that can be cured and can bond to the filler particles and the dielectric layer so as to fix the filler particles allows for more versatility in designing the insulating material. Thermally conductive layers that can be cured on the dielectric layers allow for forming an insulating material with a single dielectric layer and a thermally conductive layer disposed on a surface thereof. Silanes/siloxanes are particularly suitable carriers to provide a coating layer that sufficiently binds to the dielectric layer and fixes the filler material. Where the thermally conductive layer comprises a more fluid carrier layer, the insulating material may need to comprise a plurality of dielectric layers, and the thermally conductive layers are held in place by the pressure of compression of the dielectric layers.

The carrier component may be any appropriate carrier component material. The carrier component may comprise water, organic solvents, or a combination or two or more thereof. In one embodiment, the carrier comprises a carrier oil. Suitable oil carriers include mineral oils, vegetable oils, synthetic oils, or a combination of two or more thereof. Non-limiting examples of suitable synthetic carrier oils include, but are not limited to, polyol, esters, epoxides, silicone oils, polyolefins, etc. Such synthetic oil carriers include polyalphaolefin and polyalkylene glycol. Food grade polyalphaolefins include SPECRASYN, commercially available from ExxonMobil and SYNFLUID, commercially available from Chevron Phillips. Commercially available polyakylene glycols include EMKAROX, commercially available from Uniqema, and PLURASAFE, commercially available from BASF. Other suitable carrier oils include HATCOL 1106, a polyol ester of dipentaerythritol and short chain fatty acids, and HATCOL 3371, a complexed polyol ester of trimethylol propane, adipic acid, caprylic acid, and caprice acid (both available from Hatco Corporation, Fords, N.J.); and HELOXY 71, an aliphatic epoxy ester resin, available from Momentive Specialty Chemicals, Inc., Houston, Tex.

Suitable natural oil carriers include, but are not limited to, mineral oils and/or vegetable oils. Suitable mineral oils include, but are not limited to, paraffin, isoparrafin, and cycloparaffinic mineral oils. Suitable vegetable oils include, but are not limited to, soybean oil, canola oil, castor oil, palm oil, olive oil, corn oil, cottonseed oil, sesame seed oil, etc. The mineral or vegetable oil can also be methylated.

Suitable materials for the carrier component also include, but are not limited to, a polysiloxane, an epoxy, an acrylate, an organo-functionalized polysiloxane, a polyimide, a fluorocarbon, a benzocyclobutene, a fluorinated polyallyl ether, a polyamide, a polyimidoamide, a phenol cresol, an aromatic polyester, a polyphenylene ether (PPE), a bismaleimide, a fluororesin, mixtures thereof and any other polymeric systems known to those skilled in the art. (For common polymers, see “Polymer Handbook,” Branduf, J., Immergut, E. H; Grulke, Eric A; Wiley lnterscience Publication, New York, 4th ed. (1999); “Polymer Data Handbook,” Mark, James; Oxford University Press, New York (1999)).

In one embodiment, the carrier is a silicone based material such as a silicone fluid. For example, the silicone fluid that can be an organopolysiloxane, a silicone copolyol, a. disiloxane, trisiloxane, tetrasiloxane, or a trimethicone, an alkylsiloxane or a cyclopolysiloxane, or combinations thereof. In embodiments, the silicone based material is a polysiloxane. Examples of suitable polysiloxanes include, but are not limited to, polydimethyl siloxanes, polyalkylsiloxanes, polyarylsiloxanes, polyalkylarylsiloxanes, poly-ethersiloxane copolymers, and a combination of two or more thereof.

Representative silicone fluids include branched, unbranched, linear or cyclic silicone fluids such as those having a viscosity of about 8 centistokes or less, and having, for example from 2 to 7 silicon atoms, these silicones optionally comprising alkyl, polyether- or alkoxy groups having from 1 to 12 carbon atoms. Some non-limiting examples of silicone fluids which can be used in the invention include octamethylcyclotetrasiloxane, decamethylcyclopentasiloxane, dodecamethylcyclohexasiloxane, heptamethylhexyltrisiloxane, heptamethyloctyltrisiloxane, hexamethyldisiloxane, octamethyltrisiloxane, decamethyltetrasiloxane, dodecamethylpentasiloxane, capryl methicone, PEG/PPG 5/3 methicone, and mixtures thereof.

Also useful herein are silicone fluids such as, for example, polydimethylsiloxanes (PDMS), polydimethylsiloxanes comprising alkyl, polyether- or alkoxy groups, pendant and/or at the silicone chain end, the alkyl and alkoxy groups each having from 1 to 12 carbon atoms, phenylated silicones such as ethylmethicone, heptylmethicone, hexylmethicone, propylmethicone, isopropylmethicone, heptylmethicone, sec-butylmethicone, tert-butylmethicone, pentylmethicone, phenyltrimethicones, phenyldimethicones, phenyltrimethylsiloxydiphenylsiloxanes, diphenyldimethicones, diphenylmethyl-diphenyltrisiloxanes and (2-phenylethyl)trimethylsiloxy-silicates.

The polysiloxane can be chosen from any one of a number of commercially available materials such as, but not limited to, Silsoft 034 from Momentive Performance Materials Inc., Toray FZ-3196 from Dow Corning Inc or SilCare Silicone 41M15 from Clariant Inc, Sibrid AM 108 from Gelest, or combinations thereof. Also, mixtures such as, but not limited to, Hydrobrite 2000 Gel (from Chemtura formerly Witco) or SilCare 51M15 Trimethylsiloxysilicate in Caprylylmethicone (from Clariant) are included as polysiloxanes in the sense of the invention.

In one embodiment, the present technology provides an electrical insulating material wherein the carrier comprises a polymer or combination of two or more polymers. The polymers may be cross-linked through various mechanisms including, but not limited to: radical polymerization; anionic polymerization; cationic polymerization; polycondensation; polyaddition; hydrosilylation; Ziegler-Natta-polymerization; metathesepolymerization; or a combination of two or more thereof.

In one embodiment, the present technology provides an electrical insulating material wherein the carrier comprises a polymer or combination of two or more polymers, which may be cured thermally, using radiation (UV, electron-beam or others), at room temperature conditions, oxidative curing systems, moisture curing systems, physically (water and/or solvent based dispersions/emulsions), or a combination of two or more thereof

In one embodiment, the present technology provides an electrical insulating material wherein the carrier comprises a polymer or combination of two or more polymers, with the average molecular mass from 150 to 1,000,000 Daltons.

The polysiloxane may be the reaction product of an unsaturated compound and a hydrogen siloxane (e.g., a silyl hydride). Such polymers may be formed by reacting the compounds in the presence of a catalyst and a cure inhibitor. The reaction between these materials may be such as to form a cross linked network. Such compositions may be referred to as crosslinkable or curable compositions.

In one embodiment, the unsaturated compound is chosen from an alkenyl silicone. The alkenyl silicone may be an alkenyl functional silane or siloxane that is reactive to hydrosilylation. The alkenyl silicone may be cyclic, aromatic, or a terminally-unsaturated alkenyl silane or siloxane. The alkyenyl silicone may be chosen as desired for a particular purpose or intended application. In one embodiment the alkenyl silicone comprises at least two unsaturated groups and has a viscosity of at least about 50 cps at 25° C. In one embodiment the alkenyl silicone has a viscosity of at least about 75 cps at 25° C.; at least about 100 cps at 25° C.; at least 200 cps at 25° C.; even at least about 500 cps at 25° C. Here as elsewhere in the specification and claims, numerical values may be combined to form new and non-disclosed ranges.

In one embodiment, the alkenyl silicone is a compound of the formula:

QᵤTₚT_{p′}^{vi}D_{w}D^{vi}ₓM^{vi}_{y}M_{z},

wherein Q is SiO_{4/2}, T is R¹SiO_{3/2}, T^{vi} is R²SiO_{3/2}, D is R¹₂SiO_{2/2}, D^{vi} is R² R²SiO_{2/2}, M^{vi} is R²_{g}R¹_{3-g}SiO_{1/2}, M is R¹₃SiO_{1/2}; R² is vinyl; each occurrence of R¹ is independently C1-C18 alkyl, C1-C18 substituted alkyl, aryl, substituted aryl, wherein R¹ optionally contains at least one heteroatom; each g has a value of from 1 to 3, p is from 0 to 20, u is from 0 to 20, v is from 0 to 20, w is from 0 to 5000, x is from 0 to 5000, y is from 0 to 20, and z is from 0 to 20, provided that v+p+p′+w+x+y equals 1 to 10,000, and the valences of all of the elements in the compound containing at least one unsaturated group are satisfied.

Particular alkenyl silicones and cross-linkers chosen to generate desired mechanical, thermal and other properties of the product can be determined by those skilled in the art. Terminally-unsaturated alkenyl silicone materials are particularly suitable for forming cured or crosslinked products such as coatings and elastomers. It is also understood that two or more of these alkenyl silicones, independently selected, may be used in admixture in a cure formulation to provide desired properties.

The silyl hydride employed in the reactions is not particularly limited. It can be, for example, any compound chosen from hydrosiloxanes including those compounds of the formula MₐM^{H}_{b}D_{c}D^{H}_{d}TₑT^{H}_{f}Qₕ, where M, D, T, and Q have their usual meaning in siloxane nomenclature. The subscripts a, b, c, d, e, f, and h are such that the molar mass of the siloxane-type reactant is between 100 and 100,000 Dalton and that there are at least two hydride atoms in the silyl hydride. In one embodiment, an “M” group represents a monofunctional group of formula R³₃SiO_{1/2}, a “D” group represents a difunctional group of formula R³₂SiO_{2/2}, a “T” group represents a trifunctional group of formula R³SiO_{3/2}, and a “Q” group represents a tetrafunctional group of formula SiO_{4/2}, an “M^{H}” group represents HR³₂SiO_{1/2}, a “T^{H}” represents HSiO_{3/2}, and a “D^{H}” group represents R³HSiO_{2/2}. Each occurrence of R³ is independently C1-C40 alkyl, C1-C40 substituted alkyl, C6-C14 aryl or substituted aryl, wherein R³ optionally contains at least one heteroatom. In one embodiment, the substantially linear hydrogen siloxane is chosen from MD_{c′}D^{H}_{d′}M, MD^{H}_{d′}M, or mixtures thereof In embodiments, R³ is chosen from a C1-C20 alkyl, a C1-C10 alkyl, or a C1-C6 alkyl. In embodiments, R³ is methyl.

The catalyst for catalyzing the crosslinking reactions of these polymers can be selected from the group of a variety of organo-metallic wherein the metal is selected from the group of Ni, Ag, Ir, Rh, Ru, Os, Pd and Pt compounds. In embodiments, the catalyst for the hydrosilylation reaction of such compositions is a catalyst compound that facilitates the reaction of the silyl hydride with the olefinic hydrocarbon radicals of the alkenyl silicone and can be any platinum group metal-containing catalyst component. The catalyst may be chosen from platinum complexes, metal colloids or salts of the aforementioned metals. The catalyst can be present on a carrier such as silica gel or powdered charcoal, bearing platinum metal, or a compound or complex of a platinum metal.

A typical platinum containing catalyst component in the polyorganosiloxane compositions is any form of chloroplatinic acid, such as, for example, the readily available alcoholic solution form of the hexahydrate, because of its easy dispersibility in organosiloxane systems. A particularly useful form of the platinum complexes are the Pt⁽⁰⁾-complexes with aliphatically unsaturated organosilicon compound such as 1,3-divinyltetramethyidisiloxane, as disclosed by U.S. Pat. No. 3,419,593, incorporated herein by reference, are especially suitable. Conventional catalysts for such reactions include platinum-based compounds such as, but not limited to, Karstedt's catalyst and Ashby's catalyst.

The amount of platinum-containing catalyst component in the composition is not narrowly limited as long as there is a sufficient amount to accelerate the hydrosilylation between alkenyl silicone and the silyl hydride at the desired temperature in the required time The amount of the catalyst component will depend upon the particular catalyst, the amount of other inhibiting compounds and the SiH to olefin ratio and is not easily predictable. The amount of platinum containing catalyst component is generally provided in an amount to provide from 1 to 1000 ppm; 5 to 500 ppm; even 20 to 100 ppm by weight platinum per weight of alkenyl silicone and the silyl hydride.

It will be appreciated that the curable silicone carrier compositions may include inhibitors. Inhibitors for the platinum group metal catalysts are well known in the organosilicon art. Examples of various classes of such metal catalyst inhibitors include unsaturated organic compounds such as ethylenically or aromatically unsaturated amides (e.g., U.S. Pat. No. 4,337,332); acetylenic compounds (e.g, U.S. Pat. No. 3,445,420 and U.S. Pat. No. 4,347,346); ethylenically unsaturated isocyanates (e.g., U.S. Pat. No. 3,882,083); olefinic siloxanes (e.g., U.S. Pat. No. 3,989,667); unsaturated hydrocarbon diesters (e.g., U.S. Pat. No. 4,256,870, U.S. Pat. No. 4,476,166, and U.S. Pat. No. 4,562,096) and conjugated enzymes (e.g., U.S. Pat. No. 4,465,818 and U.S. Pat. No. 4,472,563); other organic compounds such as hydroperoxides (e.g., U.S. Pat. No. 4,061,609); ketones (e.g., U.S. Pat. No. 3,418,731); sulfoxides, amines, phosphines, phosphites, nitriles (e.g., U.S. Pat. No. 3,344,111); diazindines (e.g., U.S. Pat. No. 4,043,977); and various salts (such as, e.g., U.S. Pat. No. 3,461,185); or combinations of two or more thereof. Examples of suitable inhibitors include, but are not limited to, acetylenic alcohols, such as, e.g., ethynylcyclohexanol and methylbutynol; unsaturated carboxylic esters such as, e.g., diallyl maleate and dimethyl maleate, diethyl fumarate, diallyl fumarate, and bis-(methoxyisopropyl)maleate; half esters and amides, etc. The above-mentioned patents relating to inhibitors for platinum group metal-containing catalysts are incorporated herein by reference in their entirety.

The amount of inhibitor component is not critical and can be any amount that will retard the above-described platinum-catalyzed hydrosilylation reaction at room temperature while not preventing said reaction at moderately elevated temperature. No specific amount of inhibitor can be suggested to obtain a specified bath life at room temperature since the desired amount of any particular inhibitor to be used will depend upon the concentration and type of the platinum group metal-containing catalyst and the nature and amounts of the alkenyl silicone and silyl hydride reactants. In embodiments, the range of the inhibitor component can be 0.0006 to 10% by weight, preferably 0.05 to 2 wt. %, even 0.1 to 1 wt. %.

These crosslinkable coating compositions can be applied using devices employed on industrial equipment for the coating of e.g., paper, such as a multi-roll coating head, an air knife system or an equalizer bar system, to flexible supports or materials. The coating composition might also be applied by brush, flow, dip or spray applications. The coating can then be cured by moving through tunnel ovens heated to 50-300° C.; the passage time in these ovens depends on the temperature; this time is generally of the order of 0.5 to 20 seconds at a temperature of the order of 130° C. and of the order of 1.5 to 3 seconds at a temperature of the order of 180° C.

The polysiloxane material for the carrier may also be chosen from a photocurable or photoactivatable polymer. Photocurable means that the mixture of a Si-based polymer and an optional crosslinker, catalyst, and sensitizer can be cured under UV-light, daylight or by X-ray or other electron beam processes. Such polymers could be in some cases the same as the alkenyl silicone materials described above, but particularly suitable photocurable polymers include those selected from epoxyalkyl-, alkenyloxy, mercaptoalkyl or all types of methylacryloxy- or acryloxy-modified hydrocarbons linked to silicon by Si—C or SiO-bonds, such as methylacryloxy- or acryloxyalkyl-group containing siloxanes. Such system are disclosed e.g. by U.S. Pat. No. 4,678,846, which is incorporated herein by reference in its entirety. Weitemeyer et al. describes acrylate or methacrylate ester modified polyorganosiloxane mixtures, which can be used by themselves or in admixtures with other unsaturated compounds as radiation-curable coating compositions to obtain “good adehesive or adhesive properties towards adhesives. Still other suitable photocurable materials are described in WO 2005/063890, which is incorporated herein by reference in its entirety.

Photoactivatable organofunctional radicals may be attached to terminal silicon atoms of the photocurable polymer. The photocurable polyorganosiloxanes and their isomers may be the reaction product of a metal catalysed hydrosilylation reaction between a SiH-silane or a SiH-polyorganosiloxane and a photoactivatable olefin. Examples of photactivatable olefins include, but are not limited to, unsaturated epoxides including limoneneoxide, 4-vinyl-cyclohexeneoxide (VCHO), allylglycidylether, glycidylacrylate, 1-methyl-4-iso-propenyl cyclohexeneoxide, 7epoxy-1-octene, 2,6-dimethyl-2,3-epoxy, epoxy-7-octene, vinyinorbomenemonoxide, dicyclopentadienemonoxide, corresponding diolefins and the like. Most preferably, 4-vinylcyclohexene oxide is used as the olefinic epoxide in the process of the invention, as disclosed in U.S. Pat. No. 3,814,730; U.S. Pat. No. 3,775,452 and U.S. Pat. No. 3,715,334 or epoxysiloxanes reacted with acrylic acid. Non-limiting examples for photocurable systems include those disclosed in U.S. Pat. No. 5,593,787. The organofunctional photoactivatable groups are introduced by equilibration, condensation or polymer analogical reactions (hydrosilylation) with other siloxane units to yield preferably polydimethylsiloxane, e.g., epoxyalkyl-dimethyl siloxy terminated polydimethylsiloxanes, poly(dimethyl-co-diphenyl)siloxanes or epoxy-alkyl-methylsiloxy group containing polydimethylsiloxanes or poly(dimethyl-co-methylphenyl) siloxanes or mixtures thereof

Another class of useful polymers are branched photocurable polyorganosiloxanes include the alkenyl silicone materials described above.

The photocurable silicone materials of the carrier compositions can be also any organosilicon compound containing two or more silicon atoms linked by oxygen or divalent bridging groups wherein the silicon is bonded to 1 to 3 monovalent groups per silicon, with the proviso that the organosilicon compound contains at least two silicon-bonded photoreactive or activatable organofunctional hydrocarbon groups. This component can be a solid or a liquid, free flowing or gumlike at 25° C. In embodiments, the photocurable silicone materials are organo functional polyororganosiloxane compounds containing two or more silicon atoms with a photoreactive group.

In a non-limiting embodiment, the photocurable material is of the formula:

[MₘDₙTₒQ_{q}]ₜ

comprising units M=R⁴R₂SiO_{1/2}, D=R⁴RSiO_{2/2}, T=R⁴SiO_{3/2}, Q=SiO_{4/2}, and divalent groups of R⁵, at least more than one M-, D- and/or T-group comprising at least one photoreactive or photoactivatable group such as epoxy-, acryl-, methacryl, acrylurethane, vinylether- or mercaptoorgano group; R⁴ being chosen from n-, iso-, tertiary- or C₁-C₃₀ alkyl, alkenyl, alkoxyalkyl hydrocarbons, C₅-C₃₀ cyclic alkyl, cyclic alkenyl or, C₆-C₃₀ aryl, alkylaryl, which can be substituted by one or O—, N—, S— or F-atom, e.g. ethers or amides or C₂-C₄ polyethers with up to 1000 polyether units; t=1-5000; m=1-10; n=0-12000; o=0-50; and q=0-1; R⁵ may be chosen from a divalent aliphatic or aromatic n-, iso-, tertiary- or cyclo-C₁-C₁₄ alkylen, arylen or alkylenaryl group that bridges siloxy units and does not exceed 30 mol. % of all siloxy units.

The organofunctional polyorgansiloxanes may comprise organofunctional side group attached to silicon in the siloxane chain or terminated polydimethylsiloxanes as disclosed e.g. in U.S. Pat. No. 5,814,679 comprising units selected from following the general formula. Non-limiting examples for R⁴ are radicals such as vinyl, allyl, methallyl, 3-butenyl, 5-hexenyl, 7-octenyl, cyclohexenylethyl, limonenyl, norbomenylethyl, ethylidennorbornyl and styryl. Alkenyl radicals may be attached to terminal silicon atoms, the olefin function is at the end of the alkenyl group of the higher alkenyl radicals, because of the more ready availability of the alpha, omega-dienes used to prepare the alkenylsiloxanes.

The organofunctional group containing photocurable polydiorganosiloxanes can be prepared by any conventional methods for preparing such polydiorganosiloxanes. The cited patents disclose a variety of alternatives how to introduce the photo-reactive group. Such reactions include condensation of SiOH or SiOR containing molecules after hydrolysis of the corresponding organofunctional chlorosilane precursors, addition of unsaturated precursors bearing the photoreactive group to SiH-containing siloxanes via hydrosilylation or by an anionic or cationic catalyzed copolymerising equilibration of linear and/or of different cyclosiloxanes. For example see U.S. Pat. No. 4,370,358.

The photocurable silicone compositions may contain a catalyst and/or pohotoinitiator to promote curing. Suitable catalysts include, but are not limited to metal organic onium salts, photoinitiators, etc.

In one embodiment the catalyst for a photocurable silicone-based polymer may be chosen from any suitable onium salt. According to U.S. Pat. No. 4,977,198, the onium salts are well known, particularly for use in catalyzing cure of epoxy functional materials. Non-limiting examples of suitable onium catalysts include those described in U.S. Pat. No. 4,576,999 and references therein. Particularly suitable UV photoinitiators for curing epoxysilicones are the “onium” salts, of the general formulas R⁶₂I⁺MXₙ⁻, R⁶₃S⁺MXₙ⁻, R⁶₃Se⁺MXₙ⁻R⁶₄P⁺MXₙ⁻, R⁶₄N⁺MXₙ⁻, where different radicals represented by R⁶ can be the same or different organic radicals with C1 to C30 aliphatic hydrocarbons, including aromatic carbocyclic radicals from 2 to 20 carbon atoms which can be substituted. The complex onium anion may selected from the group MXₙ, wherein MX is a non-basic, non-nucleophilic anion, such as BF₄⁻, PF₆⁻, AsF₆⁻, SbF₆⁻, SbCl₆, H50₄⁻, ClO₄⁻, and the like. Examples of suitable photocurable systems and the use of onium salts include those described in U.S. Pat. No. 4,421,904, which is incorporated herein as reference.

Other onium catalysts are known in the art, like the borate types of EP 0703236 or U.S. Pat. No. 5,866,261 such as, for example, B(C₆F₅)₄⁻.

The photoinitiators may be mono- or multi-substituted mono, bis or trisaryl salts.

The complexed onium cation is selected from the elements of the group VII, VI and V.

The photoinitiator can be chosen as desired for a particular purpose or intended application. Examples of suitable photoinitiators include, benzophenones, phosphine oxides, nitroso compounds, acryl halides, hydrazones, mercapto compounds, pyrillium compounds, triacrylimidazoles, benzimidazoles, chloroalkyl triazines, benzoin ethers, benzyl ketals, thioxanthones, camphorquinone, and acetophenone derivatives.

In one embodiment, the photoinitiator is chosen from an acylphosphine. The acyl phosphine can be a mono- or bis-acylphoshine. Examples of suitable acylphosphine oxides include those described in U.S. Pat. No. 6,803,392, which is incorporated herein by reference.

Specific examples of suitable acylphosphine photoinitiators include, but are not limited to, diphenyl(2,4,6-trimethylbenzoyl)phosphine oxide (DAROCUR® TPO), diphenyl(2,4,6-trimethylbenzoyl)phosphine oxide (ESACURE® TPO, LAMBERTI Chemical Specialties, Gallarate, Italy), diphenyl(2,4,6-trimethylbenzoyl)phosphine oxide (FIRSTCURE® HMPP available from Albemarle Corporation, Baton Rouge, La.), diphenyl(2,4,6-trimethylbenzoyi)phosphine oxide (LUCIRIN® TPO, available from BASF (Ludwigshafen, Germany), diphenyl(2,4,6-trimethylbenzoyl)phosphinate (LUCIRIN® TPO-L), phenyl bis(2,4,6-trimethyl benzoyl)phosphine oxide (IRGACURE® 819, available from Ciba Specialty Chemicals, Tarrytown, N.Y.), and bis(2,6-di-methoxybenzoyl)-2,4,4-trimethylpentylphosphine oxide (as IRGACURE® 1700, IRGACURE® 1800 and IRGACURE® 1850 in admixture with a-hydroxyketones from Ciba Spezialitatenchemie).

Examples of a-hydroxyketone photoinitiators can include 1-hydroxy-cyclohexylphenyl ketone (IRGACURE® 184), 2-hydroxy-2-methyl-1-phenyl-1-propanone (DAROCUR® 1173), and 2-hydroxy-1-[4-(2-hydroxyethoxy)phenyl]-2-methyl-1-propanone (IRGACURE® 2959), all available from Ciba Specialty Chemicals (Tarrytown, N.Y.).

Examples of α-aminoketones photoinitiators can include 2-benzyl-2-(dimethylamino)-1-[4-(4-morpholinyl)phenyl]-1-butanone (IRGACURE® 369), and 2-methyl-1-[4-(methylthio)phenyl]-2-(4-morpholinyl)-1-propanone (IRGACURE® 907), both available from Ciba Specialty Chemicals (Tarrytown, N.Y.).

The photocurable silicon compounds may be cured by exposing the composition to UV or visible light. In one embodiment, the wavelength of the light can be from about 200 nm to about 420 nm.

The carrier may be present in an amount of from about 0 to about 95 weight percent of the thermally conductive layer; about 10 to about 80 weight percent of the thermally conductive layer; about 25 to about 60 weight percent of the thermally conductive layer; even about 40 to 50 weight percent of the thermally conductive layer. Here, as elsewhere in the specification and claims, numerical values can be combined to form new and non-disclosed ranges.

The thermally conductive layer may have a thickness as desired for a particular purpose or intended application. In embodiments, the thermally conductive layer may have a thickness of from about 0.2 micron to about 500 micron, from about 1 micron to about 250 micron, from about 2 to about 100 micron, from about 5 micron to about 50 micron, even about 10 micron to about 25 micron. Here as elsewhere in the specification and claims, numerical values may be combined to form new and non-disclosed ranges.

The thermally conductive layer may also include additional appropriate fillers. For example, in certain applications, a fire retardant feature may be needed and/or may be required by applicable regulations in an amount ranging from 0.5 up to 10 wt. %. For example, electrical insulating materials used in electric or electronic applications may be directly exposed to electrical current, to short circuits, and/or to heat generated from the use of the associated electronic component or electrical device. Consequently, industry standards or regulations may impose conditions on the use of such insulation materials that require qualifying tests be performed, such as burn tests, and the like. Fire retardants suitable for inclusion in the thermally conductive layer can be intumescent fire retardants and/or non-intumescent fire retardants. In other embodiments, the fire retardants are non-halogen containing and antimony-free. Blends of one or more fire retardants and/or a synergist and/or smoke suppressants may also be used in the thermally conductive layer of the technology. Selection of the fire retardant system will be determined by various parameters, for example, the industry standard for the desired application, and by composition of the thermally conductive layer. The fire retardant may increase lubricious movement of the thermally conductive layer and may help to increase the elastic strength of the dielectric layers.

The thermally conductive layer may also include a number of other additives other than materials expressly excluded above. Examples of suitable additives include bentonite, tackifiers (e.g., rosin esters, terpenes, phenols, and aliphatic, aromatic, or mixtures of aliphatic and aromatic synthetic hydrocarbon resins), pigments, reinforcing agents, hydrophobic or hydrophilic silica, calcium carbonate, toughening agents, fibers, fillers, antioxidants, stabilizers, and combinations thereof. The foregoing additional agents and components are generally added in amounts sufficient to obtain an article having the desired end properties, in one embodiment, adhesive properties.

The composition for the thermally conductive layer can be made by any suitable method. In one embodiment, boron nitride and any other fillers are added into the carrier component, and the mixture may be manually or mechanically agitated until the boron nitride and other fillers are fairly uniformly dispersed through the carrier component.

The amount of thermally conductive filler, e.g., boron nitride, based on the total weight of the electrical insulating material may vary. It will be appreciated that the amount of thermally conductive filler based on the total weight of the electrical insulating material generally not limited. The amount of thermally conductive filler based on the total weight of the electrical insulating material may be approximately 0.1 to 80 wt. % of the total weight of the insulating material; 0.1 to 50 wt. %; 1 to 50 wt. %; 15 to 40 wt. %; even 20 to 30 wt. % of the total weight of the insulating material. Here, as elsewhere in the specification and claims, numerical values can be combined to form new or non-disclosed ranges.

The electrical insulating material may have a thermal conductivity that may range from about 0.1 to about 5 W/mK; from about 0.5 to about 4 W/mK; from about 1 to about 3 W/mK; even from about 1.5 to about 2.5 W/mK. Here, as elsewhere in the specification and claims, numerical values can be combined to form new and non-disclosed ranges.

The present technology also provides a method of making the electrical insulating material. An electrical insulating material in accordance with the present technology can be produced by coating a surface of a dielectric layer with a thermally conductive layer comprising a thermally conductive filler material and applying another dielectric layer to the coated surface of the other dielectric layer.

The thermally conductive layer may be applied to a respective dielectric layer by any appropriate coating technique, including, but not limited to, spraying, curtain coating, brushing, roll, roll to roll, mayer bar, knife, casting, spraying and printing pouring, etc. It will be appreciated that the coating technique may involve coating an entire surface of a dielectric layer, or it may involve coating less than an entire surface of a dielectric layer. The thermally conductive layer may be coated on anywhere from 0-100% of the surface. For example, the thermally conductive layer may be coated on 80% of the surface, 60% of the surface, 40% of the surface, 20% of the surface or even less than 1% of the surface.

To produce an electrical insulating material, pressure may be applied to the electrical insulating material to sufficiently associate the dielectric layers. This pressure may come in the form of manual pressure, air pressure, heat pressure, including, but not limited to, force from a piece of equipment, such as a press, vice, roller, or weight. Without being bound to any particular theory, the electrical insulating material may compress and the capillary force between the thermally conductive layer and the dielectric layers may bond or maintain the association between the dielectric layers. Alternatively, the thermally conductive layer may contain a material, e.g., an adhesive such as an epoxy that allows for adhesion of the dielectric layers.

This method may be continued with the addition of more dielectric layers and additional thermally conductive layers as may be desired to provide a selected configuration. A pressure may be applied after each consecutive dielectric layer is added or a pressure may be added after several or all of the dielectric layers are added.

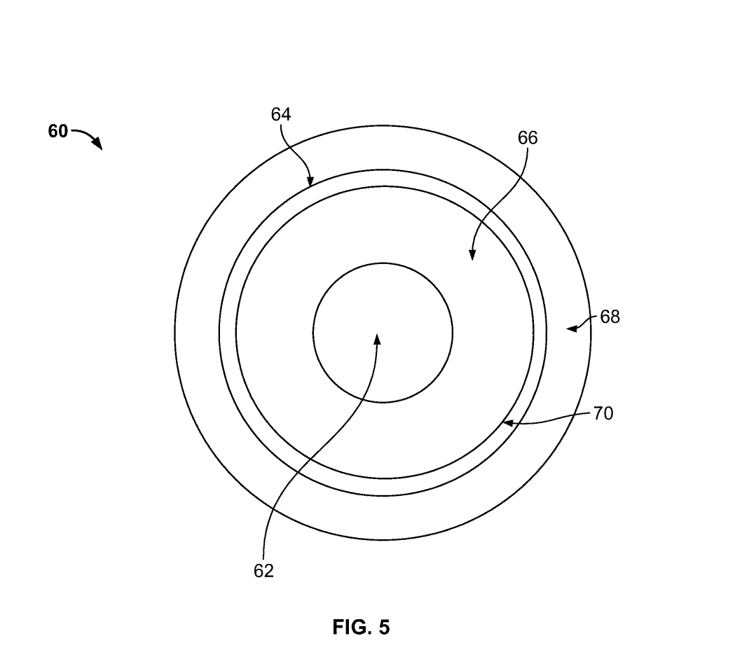

The electrical insulating material may be used as part of an electrically conductive apparatus, such as to wrap or encase a particular component. As shown in FIG. 5, the present technology also provides an electrically conductive apparatus 60 comprising an electrically conductive material 62 and electrical insulating material 64 disposed about the conductive material 62. The electrical insulating material 64 comprises a first dielectric layer 66, a second dielectric layer 68 overlying the first dielectric layer 66, and a thermally conductive layer 70 disposed between the first dielectric layer 66 and the second dielectric layer 68.

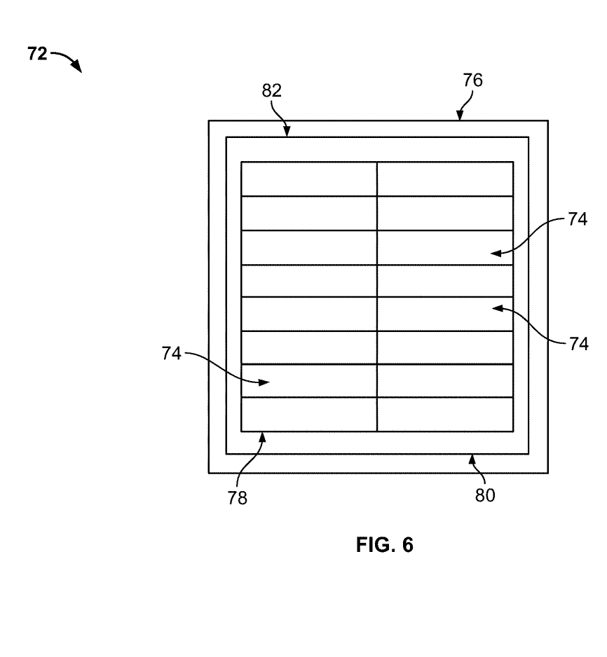

In FIG. 6, an electrically conductive apparatus 72 comprises several conductive material components 74 and an electrical insulating material 76 disposed about the conductive material 74. The electrical insulating material 76 comprises a first dielectric layer 78, a second dielectric layer 80 overlying the first dielectric layer 78, and a thermally conductive layer 82 disposed between the first dielectric layer 78 and the second dielectric layer 80. The thermally conductive layer 82 comprises a thermally conductive filler.

The electrical insulating material exhibits good thermal conductivity. The electrical insulating material can provide an electrical insulator with excellent thermal conductivity without compromising the electrical insulation and other performance properties. The electrical insulating material is capable of dissipating heat and allowing for more efficient electrical conversion.

The electrical insulating material exhibits good thermal resistance of paper. Additionally, the electrical insulating material exhibits improved dielectric properties of paper due, in part, to electrical isolating properties of boron nitride and silicone coating. The electrical insulating material maintains its elastic properties, due to the elasticity of the coating and also maintains its water uptake properties due to the water permeability of the coating.

The electrically conductive material may be a metal or any electrically conductive material. For example, the metal may be in any appropriate form, including, but not limited to, cables, wires, pipes, transformers, capacitors, coils, motors, generators, etc.

The electrical insulating material may be selectively attached to the electrically conductive apparatus by any appropriate means, including, but not limited to, an adhesive, manual pressure, or any other force. Additionally, the electrical insulating material may have additional dielectric layers with additional thermally conductive layers between each dielectric layer.

### EXAMPLES

Samples of electrical insulating material made with boron nitride were measured for thermal conductivity and compared against a control sample of electrical insulating material without boron nitride.

### Examples 1-2

### Insulating Materials with Boron Nitride-Polysiloxane Layers

The sample electrical insulating materials were formed with multiple cellulose paper layers with a layer of boron nitride platelet/agglomerates mixed with polysiloxane coated between each paper layer. The boron nitride used was Momentive grade HCP and HCPL boron nitride. The paper used was cellulose KRAFT paper.

The insulation papers used in the insulation material were first dried at 120° C. for 24 hours, evacuated for 24 hours before being coated with a boron nitride-polysiloxane composition. The weight ratio of boron nitride to polysiloxane in the coating composition was 35 wt. % for a HCP sample (Example 1) and 40 wt. % for a HCPL sample (Example 2). The coating composition comprises: 100 parts per weight of a vinyl end-stopped polydimethylsiloxane (vinyl content is 0.9 wt. %) of approximately 130 mPa·s at 25° C. of the general formula M^{vi}₂-D₈₀; 6.35 parts of a polymethylhydrogensiloxane of the formula Me₃SiO(Me₂SiO)₁₅(MeHSiO)₃₀SiMe₃ having a viscosity of 30 mPa·s hydride content 1.05 wt. %) at 25° C. providing a molar Si^{H}/Si^{Vi} ratio of 2.0; 0.25 pw of an inhibitor, specifically Ethynylcyclohexanol; and a Pt(0)-complex having vinylsiloxane ligands (Pt-Karstedt catalyst) providing 30 ppm of platinum-catalyst; and 25 parts by weight of BN. The components of the composition were mixed together at 25° C. in a beaker with a mixer.

The coating mixture was coated on KRAFT paper using a mayer-bar and cured at a temperature of 130° C. for 20 seconds. The coat weight reached was 40 grams per square meter.

Thermal conductivity of the samples was measured with laser flash analysis (NANOFLASH) for through plane thermal conductivity and in plane thermal conductivity. HOTDISK was used as a measurement of bulk thermal conductivity. For laser flash analysis, the sample electrical insulating materials were formed with 5 cellulose paper layers with a layer of HCP or HCPL mixed with polysiloxane coated between each paper layer. For HOTDISK analysis, the sample electrical insulating materials were formed with 50 cellulose paper layers with a layer of HCP or HCPL mixed with polysiloxane coated between each paper layer. All the samples were immersed in mineral oil for 24 hours in a vacuum before the measurements.

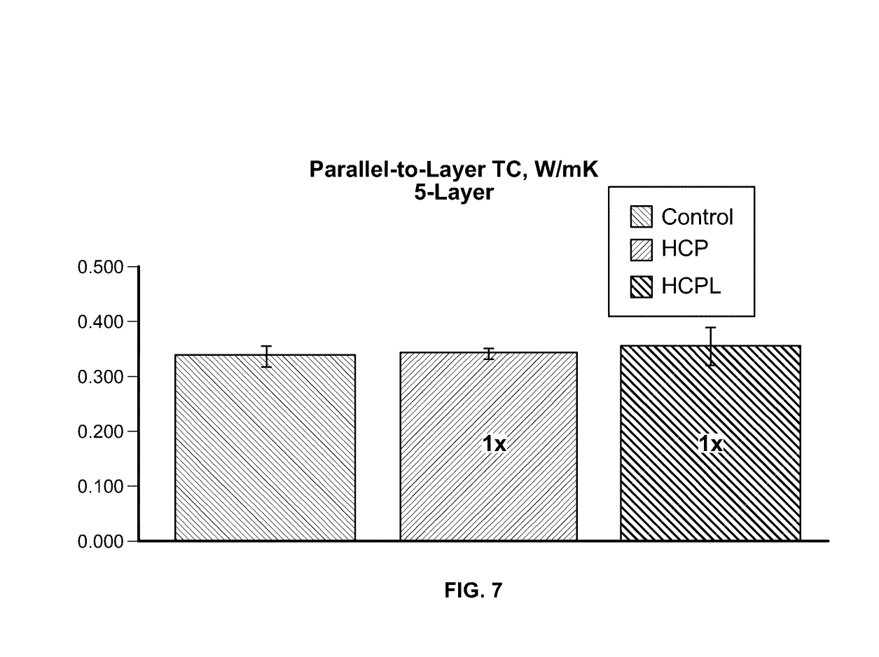

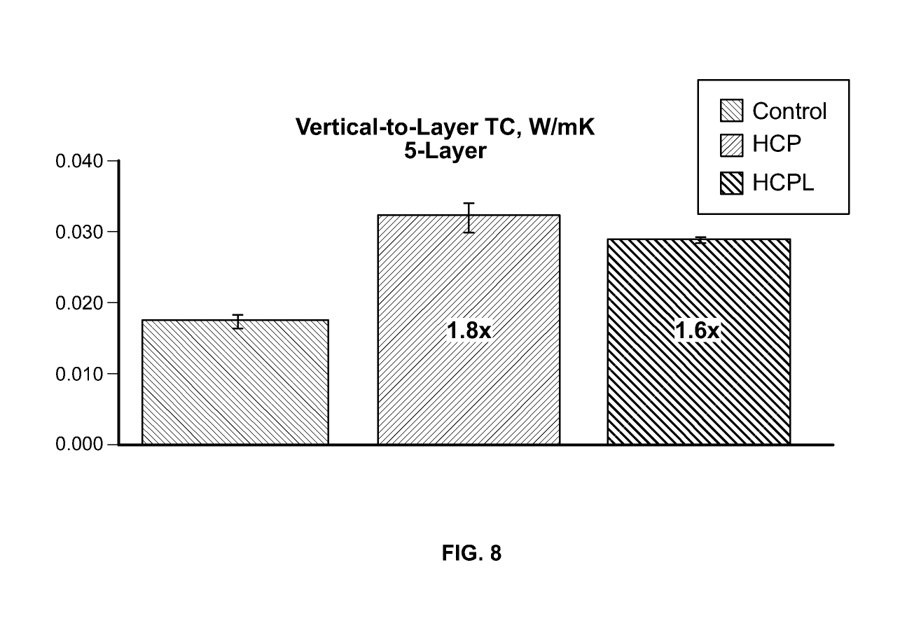

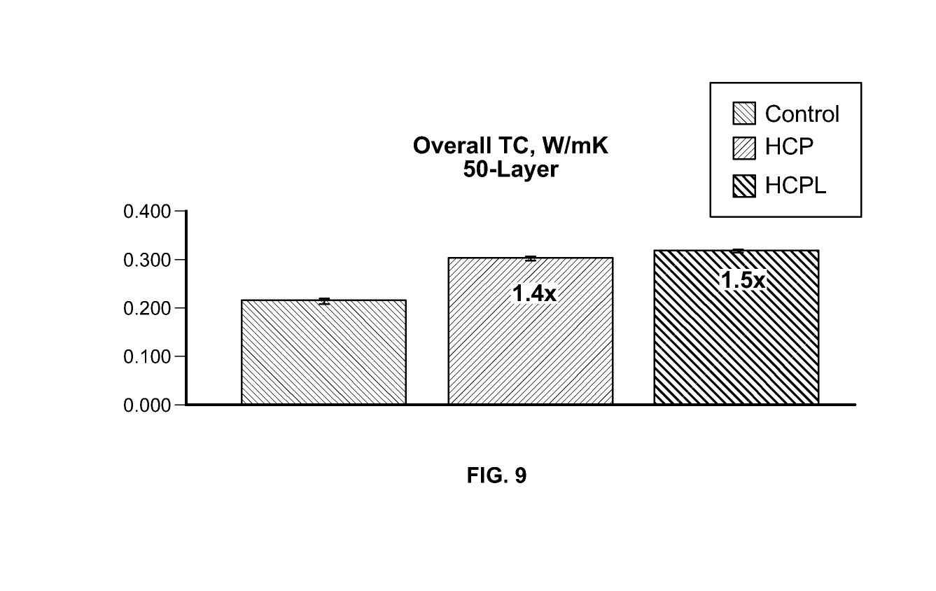

As shown in FIGS. 7-9, both the electrical insulating material in accordance with the present technology showed improved thermal conductivity compared to the conventional electrical insulating material with no boron nitride (Control). While having a similar in-plane thermal conductivity to the control, Examples 1 and 2 showed improved through-plane thermal conductivity and overall thermal conductivity compared to the control.

### Examples 3-8

### Insulating Material with Boron Nitride-Mineral Oil Thermally Conductive Layers

The sample electrical insulating materials were formed with multiple cellulose paper layers with a layer of boron nitride platelet/agglomerates mixed with mineral oil coated between each paper layer. The boron nitride used was Momentive grade HCP and HCPL boron nitride. The paper used was cellulose KRAFT paper. The loading of boron nitride was varied through the experiment.

The insulation papers used in the insulation material were first dried at 120° C. for 24 hours, evacuated for 24 hours before being coated with a boron nitride-mineral oil composition to provide an electrical insulating material with a 13-15% wt. loading of the boron nitride based on the total weight of the electrical insulating material. The weight ratio of boron nitride to mineral oil in the coating composition was 3:7. The electrical insulating materials were pressed in a Hull Press at 1700 PSI for 10 minutes. The samples were punched into 1 inch disks for thermal conductivity testing.

Thermal conduciveness of the samples was measured with laser flash analysis (NANOFLASH) for through plane thermal conductivity and in plane thermal conductivity. HOTDISK was used as a measurement of bulk thermal conductivity. For laser flash analysis, the sample electrical insulating materials were formed with both 5 cellulose paper layers with a layer of HCP (Example 3) or HCPL (Example 4) mixed with polysiloxane coated between each paper layer and 10 cellulose paper layers with a layer of HCP (Example 5) or HCPL (Example 6) mixed with polysiloxane coated between each paper layer. For HOTDISK analysis, the sample electrical insulating materials were formed with both 10 cellulose paper layers with a layer of HCP or HCPL mixed with polysiloxane coated between each paper layer and 50 cellulose paper layers with a layer of HCP (Example 7) or HCPL (Example 8) mixed with polysiloxane coated between each paper layer.

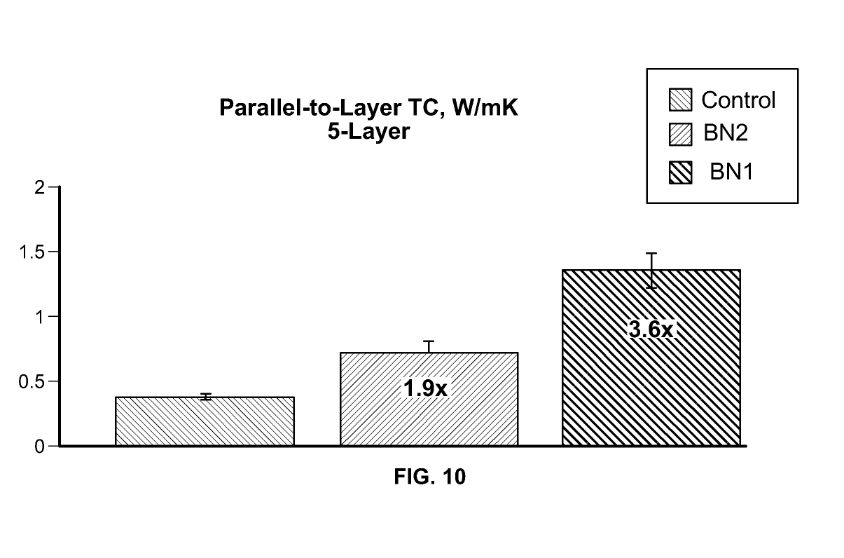

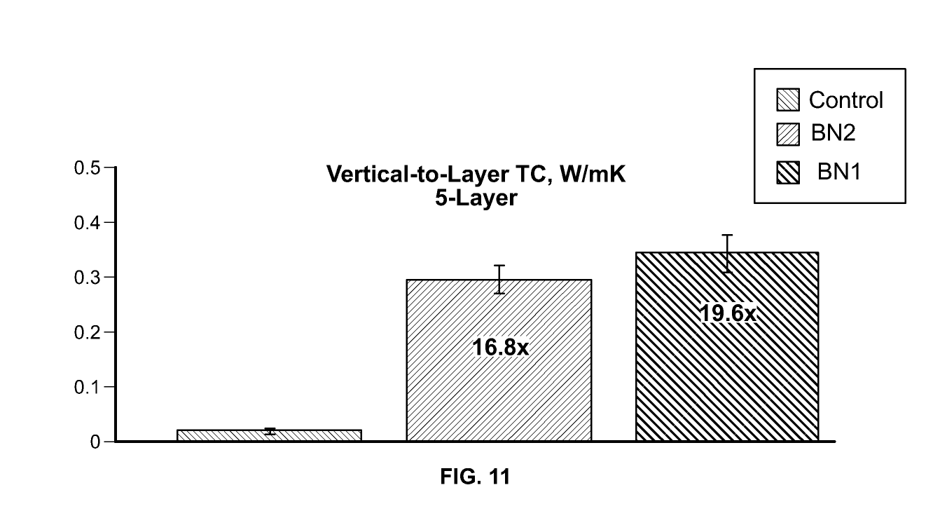

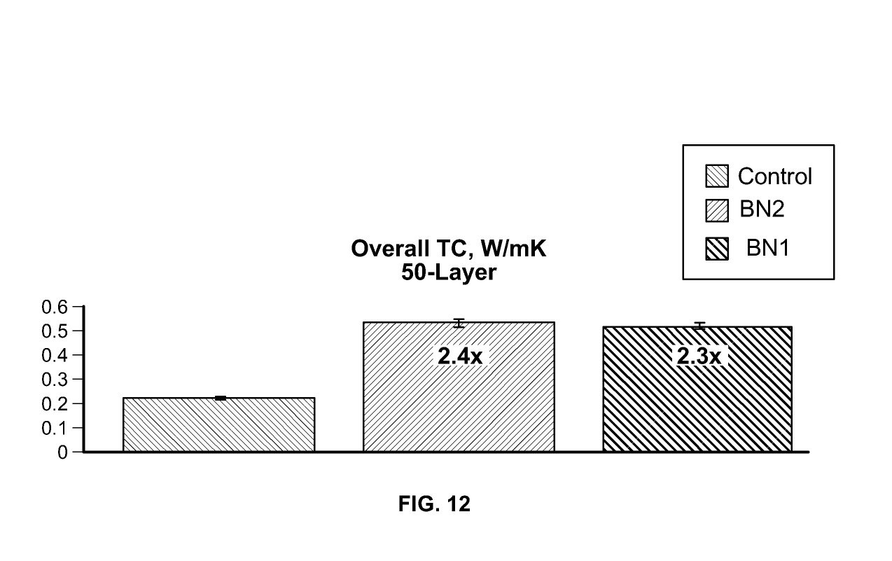

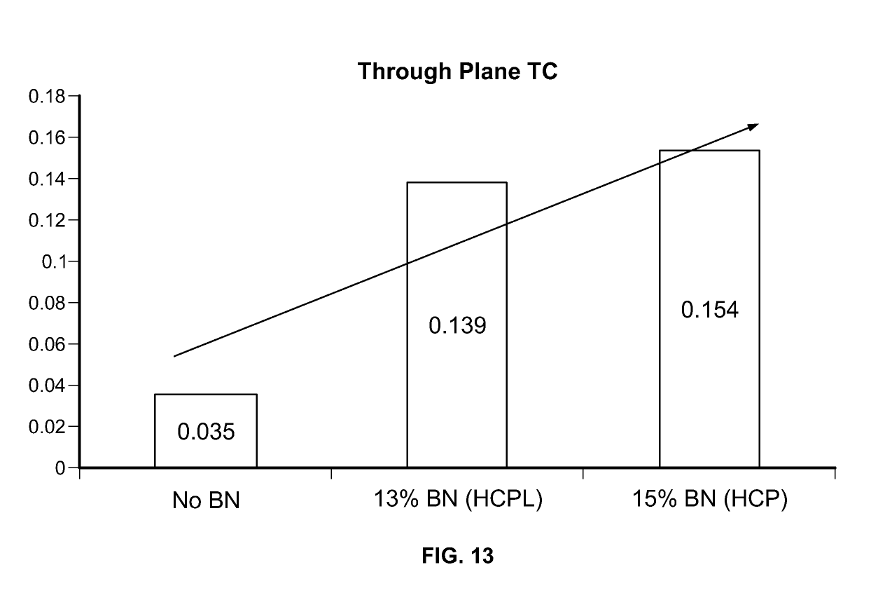

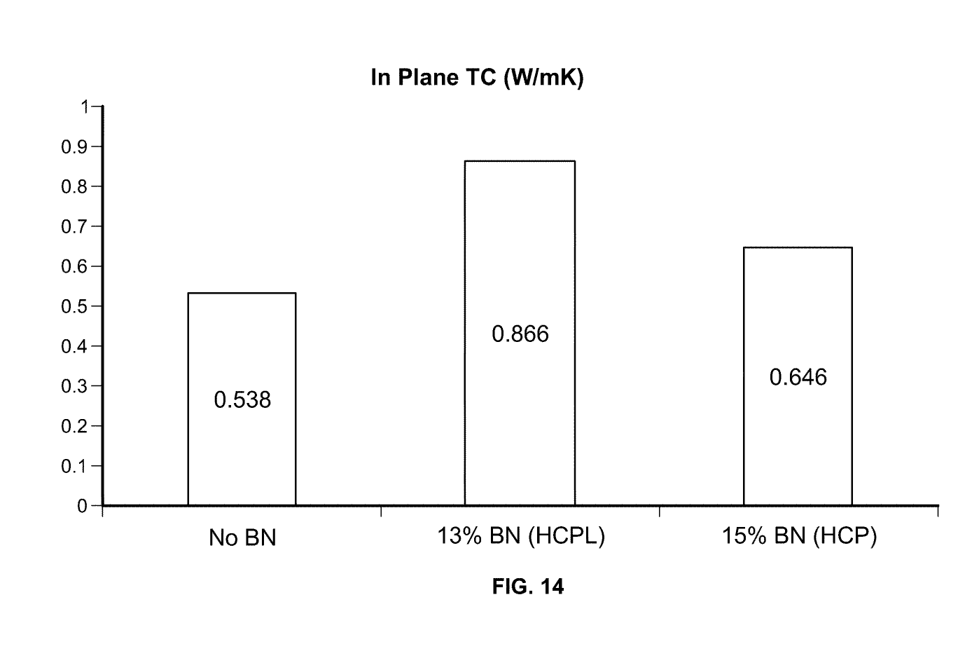

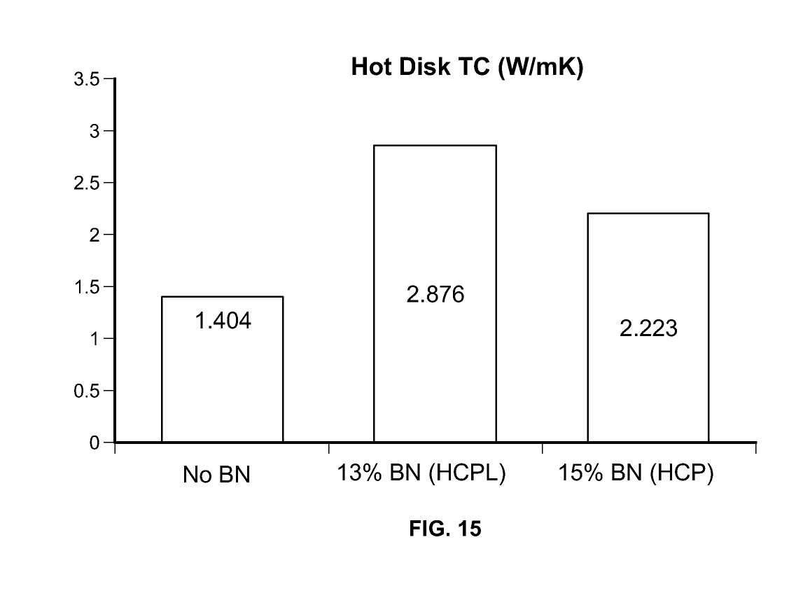

As shown in FIGS. 10-15, both the electrical insulating material in accordance with the present technology showed improved thermal conductivity compared to the conventional electrical insulating material with no boron nitride (Control).

Embodiments of the technology have been described above and modifications and alterations may occur to others upon the reading and understanding of this specification. The claims as follows are intended to include all modifications and alterations insofar as they come within the scope of the claims or the equivalent thereof

1. An electrical insulating material comprising:
a plurality of dielectric layers; and
a thermally conductive layer disposed between adjacent dielectric layers, the thermally conductive layer comprising a thermally conductive filler.

2. The electrical insulating material of claim 1, wherein the thermally conductive layer comprises a thermally conductive filler disposed in a carrier.

3. The electrical insulating material of claim 2, wherein the thermally conductive filler is selected from hexagonal boron nitride, zinc oxide, glass fiber, glass flake, clays, exfoliated clays, calcium carbonate, talc, mica, wollastonite, aluminosilicate, aluminum nitride, graphite, metallic powders or flakes of aluminum, copper, bronze, or brass, or a combination of two or more thereof, fibers or whiskers of aluminum, copper, bronze, brass, silicon carbide, silicon nitride, aluminum nitride, alumina, zinc oxide, or a combination of two or more thereof, carbon nanotubes, graphene, boron nitride nanotubes, boron nitride nanosheets, boron nitride fibers, zinc oxide nanotubes, or a combination of two or more thereof

4. The electrical insulating material of claim 2, wherein the thermally conductive filler further comprises an additive selected from bentonite, tackifiers, aliphatic rosin esters, terpenes, phenols, aliphatic synthetic hydrocarbon resins, aromatic synthetic hydrocarbon resins, pigments, reinforcing agents, hydrophobic silica, hydrophilic silica, calcium carbonate, toughening agents, fibers, fillers, antioxidants, stabilizers, and combinations of two or more thereof.

5. The electrical insulating material of claim 2, wherein the carrier is chosen from water, an organic solvent, or a combination thereof.

6. The electrical insulating material of claim 2, wherein the carrier is a carrier oil chosen from a mineral oil, a vegetable oil, a polyol, an ester, an epoxide, a silicone oil, a polyolefin, a polyalphaolefin glycol, a polyalkylene glycol, a paraffin, an isoparrafin, a cycloparaffinic mineral or a combination of two or more thereof.

7. The electrical insulating material of claim 2, wherein the carrier material is chosen from a resin.

8. The electrical insulating material of claim 2, wherein the carrier material is chosen from an epoxy, a polydimethylsiloxane, an acrylate, an organo-functionalized polysiloxane, a polyimide, a fluorocarbon, a benzocyclobutene, a fluorinated polyallyl ether, a polyamide, a polyimidoamide, a phenol cresol, an aromatic polyester, a polyphenylene ether (PPE), a bismaleimide, a fluororesin, or a combination of two or more thereof

9. The electrical insulating material of claim 2, wherein the carrier material is chosen from a silicone, polydimethyl siloxane, polyalkylsiloxane, polyarylsiloxane, polyalkylarylsiloxane, polyethersiloxane copolymers, or a combination of two or more thereof.

10. The electrical insulating material of claim 2, wherein the carrier material is chosen from a polymer or combination of two or more polymers.

11. The electrical insulating material of claim 10, wherein the polymers are cross-linked by the following mechanisms: radical polymerization; anionic polymerization;
kationic polymerization; polycondensation; polyaddition; hydrosilylation; Ziegler-Natta-polymerization; metathesepolymerization; or a combination of two or more thereof.

12. The electrical insulating material of claim 10, wherein the polymers are cured by the following methods: cured thermally; cured by radiation; cured at room temperature conditions; cured by an oxidative-curing system; cured by a moisture-curing system; physically cured; or a combination of two or more methods thereof

13. The electrical insulating material of claim 10, wherein the polymers have an average molecular weight from about 150 to about 1,000,000 Daltons.

14. The electrical insulating material of claim 2, wherein the thermally conductive layer comprises a thermally conductive filler in an amount of 0.1 weight percent to about 80 weight percent.

15. The electrical insulating material of claim 2, wherein the thermally conductive filler comprises boron nitride platelets, agglomerates, nanoparticles, nanosheets, fibers, or a combination of two or more thereof.

16. The electrical insulating material of claim 2, wherein the electrical insulating material has a total thermally conductive filler loading of from about 5 percent to about 50 percent by weight of the electrical insulating material.

17. The electrical insulating material of claim 2, wherein the thermal conductivity of the electrical insulating material is at least 0.1 W/mK.

18. The electrical insulating material of claim 2, wherein the thermally conductive layer further comprises a fire retardant material.

19. The electrical insulating material of claim 2, wherein the dielectric layers are chosen from a woven fibrous material, a non-woven fibrous material, a film, a laminate, or a combination of two or more thereof.

20. The electrical insulating material of claim 2, comprising at least two dielectric layers.

21. The electrical insulating material of claim 2, comprising at least five dielectric layers.

22. The electrical insulating material of claim 2, comprising at least ten dielectric layers.

23. The electrical insulating material of claim 2, comprising 2-15 dielectric layers.

24. An electrically conductive apparatus comprising
an electrically conductive material; and
an electrical insulating material disposed about the conductive material, the electrical insulating material comprising the electrical insulating material of claim 1.

25. An electrical insulating material comprising:
a first dielectric layer;
a second dielectric layer overlying the first dielectric layer; and
a thermally conductive layer disposed between the first and second dielectric layers, the thermally conductive layer comprising a thermally conductive filler.

26. An electrical insulating material comprising:
a dielectric layer having a first and second surface; and
a first thermally conductive layer disposed about the first surface of the dielectric layer, the thermally conductive layer comprising a first thermally conductive filler.

27. The electrical insulating material of claim 26 further comprising a second thermally conductive layer disposed about the second surface of the dielectric layer, the second thermally conductive layer comprising a second thermally conductive filler.

28. An electrically conductive apparatus comprising
an electrically conductive material; and
an electrical insulating material disposed about the conductive material, the electrical insulating material comprising a first dielectric layer; a second dielectric layer overlying the first dielectric layer; and a thermally conductive layer disposed between the first and second dielectric layers, the thermally conductive layer comprising a thermally conductive filler.

29. A method for manufacturing an electrical insulating material comprising the steps of:
(i) coating an exposed surface of a first dielectric layer with a composition comprising a thermally conductive filler disposed in a carrier; and
(ii) applying a second dielectric layer onto the coated surface of the first dielectric layer comprising the coating to provide an insulation material.

30. The method of claim 29, further comprising the step of applying pressure to the electrical insulating material.

31. The method of claim 29, further comprising the steps of coating an exposed surface of the second dielectric layer with the coating composition and applying a third dielectric layer onto the coated surface of the second dielectric layer.

32. An electrical insulating material comprising:
a plurality of dielectric layers chosen from a paper material, a cellulosic based material, or a combination of two or more thereof; and
a thermally conductive layer disposed between adjacent dielectric layers, the thermally conductive layer comprising a boron nitride filler disposed in a carrier chosen from a mineral oil, a silicone based material, or a combination of two or more thereof.

33. The insulating material of claim 32, wherein the boron nitride filler is chosen from hexagonal boron nitride, platelet boron nitride, an agglomerate of boron nitride, a boron nitride nanotube, a boron nitride fiber, a boron nitride nanosheet, or a combination of two or more thereof.

34. The insulating material of claim 32, wherein the carrier comprises an organofunctionalized siloxane.

35. The insulating material of claim 32, wherein the carrier comprises polydimethylsiloxane.

36. The insulating material of claim 32, wherein at least one of the plurality of dielectric layers comprises KRAFT paper.

37. The insulating material of claim 32, wherein at least one of the plurality of dielectric layers comprises a cellulosic based material.

38. The insulating material of claim 32, wherein the thermally conductive layer comprises the boron nitride filler in an amount of from about 15 to about 50 wt. %, and the carrier in an amount of from about 50 to about 85 wt. %.

39. The insulating material of claim 32, wherein the thermally conductive layer comprises the boron nitride filler in an amount of from about 20 to about 40 wt. %, and the carrier in an amount of from about 60 to about 80 wt. %.

40. A composition comprising (a) a curable silicone-based composition;
and (b) a boron nitride filler material.

41. The composition of claim 40, wherein the curable silicone-based composition is chosen from a photocurable composition, a thermal curable composition, or a combination of two or more thereof

42. The composition of claim 40, wherein the curable silicone-based composition comprises an unsaturated silicone and a silyl hydride.

43. The composition of claim 40, wherein the unsaturated silicone compound is chosen from an alkenyl silicone compound of the formula:
QᵤTₚT_{p′}^{vi}DₓM^{vi}_{y}M_{z},
wherein Q is SiO_{4/2}, T is R¹SiO_{3/2}, T^{vi} is R²SiO_{3/2}, D is R¹₂SiO_{2/2}, D^{vi} is R¹ R²SiO_{2/2}, M^{vi} is R²_{g}R¹_{3-g}SiO_{1/2}, M is R¹₃SiO_{1/2}; R² is vinyl; each occurrence of R¹ is independently C1-C18 alkyl, C1-C18 substituted alkyl, aryl, substituted aryl, wherein R¹ optionally contains at least one heteroatom; each g has a value of from 1 to 3, p is from 0 to 20, u is from 0 to 20, v is from 0 to 20, w is from 0 to 5000, x is from 0 to 5000, y is from 0 to 20, and z is from 0 to 20, provided that v+p+p′+w+x+y equals 1 to 10,000, and the valences of all of the elements in the compound containing at least one unsaturated group are satisfied; and
the silyl hydride is chosen from a compound of the formula M′ₐM^{H}_{b}D′_{c}D^{H}_{d}T′ₑT^{H}_{f}Q∝ₕ, where subscripts a, b, c, d, e, f, and h are such that the molar mass of the siloxane-type reactant is between 100 and 100,000 Dalton and that there are at least two hydride atoms in the silyl hydride. M′ group is chosen from a monofunctional group of formula R³₃SiO_{1/2}, D′ is chosen from a difunctional group of formula R³₂SiO_{2/2}, T′ is chosen from a trifunctional group of formula R³SiO_{3/2}, and Q′ is chosen from a tetrafunctional group of formula SiO_{4/2}, M^{H} is chosen from HR³₂SiO_{1/2}, T^{H} is chosen from HSiO_{3/2}, D^{H} is chosen from R³HSiO_{2/2}, where each occurrence of R³ is independently C1-C40 alkyl, C1-C40 substituted alkyl, C6-C14 aryl or substituted aryl, wherein R³ optionally contains at least one heteroatom.

44. The composition of claim 44, wherein the alkenyl silicone is a compound of the formula M^{vi}D_{w}M^{vi}.

45. The composition of claim 40, wherein the boron nitride filler is chosen from hexagonal boron nitride, platelet boron nitride, an agglomerate of boron nitride, a boron nitride nanotube, a boron nitride fiber, a boron nitride nanosheet, or a combination of two or more thereof

46. A dielectric layer coated with the composition of the claim 40.
